(19) United States
(12) Patent Application Publication
(10) Pub. No.: US 2014/0370417 A1
(43) Pub. Date: Dec. 18, 2014

(54) ANION EXCHANGE MEMBRANE, METHOD FOR PRODUCING THE SAME, AND FUEL CELL USING THE SAME

(71) Applicant: NITTO DENKO CORPORATION, Ibarake-shi, Osaka (JP)

(72) Inventors: Koso Matsuda, Osaka (JP); Hideyuki Emori, Osaka (JP); Megumu Nagasawa, Osaka (JP); Hiroyuki Nishii, Osaka (JP); Takashi Suzuki, Osaka (JP)

(21) Appl. No.: 14/374,130

(22) PCT Filed: Jan. 23, 2013
(86) PCT No.: PCT/JP2013/000319

§ 371 Date: Jul. 23, 2014

(30) Foreign Application Priority Data
Jan. 25, 2012 (JP) 2012-012947

(51) Int. Cl. H01M 8/10; B01J 19/08

(52) U.S. Cl. CPC H01M 8/1039; B01J 19/081; H01M 8/1027; H01M 8/1025; H01M 2008/1095; H01M 2300/0082
USPC 429/492; 204/157.63; 204/157.64; 204/157.65

(57) ABSTRACT

A method of the present invention for producing an anion exchange membrane includes the steps of: (i) irradiating a first polymer film with radiation; and (ii) graft-polymerizing a monomer containing a site into which a functional group having anion conducting ability can be introduced and an unsaturated carbon-carbon bond onto the radiation-irradiated first polymer film so as to form a second polymer film containing grafted chains. This method further includes the subsequent steps of: (a) subjecting the second polymer film to a treatment including irradiation with radiation so as to introduce a crosslinked structure into the grafted chains; and (b) introducing the functional group having anion conducting ability into the site.

### TECHNICAL FIELD

The present invention relates to an anion exchange membrane, a method for producing the same, and a fuel cell using the same, and in particular to a crosslinked anion exchange membrane for use in, for example, an anion exchange membrane fuel cell, and a method for producing the same.

### BACKGROUND ART

Polymer electrolyte fuel cells are a type of fuel cell in which an ion exchange membrane is used as a solid electrolyte. They operate at relatively low temperatures, have high power densities, and produce, in principle, only water as an emission. Therefore, with recent growing social concerns about energy issues and global environmental issues, great expectations have been placed on polymer electrolyte fuel cells.

Cation exchange membranes are usually used as ion exchange membranes for use in polymer electrolyte fuel cells. However, since cation exchange membranes are highly acidic, only a limited number of metals, such as platinum, can be used as catalysts. Catalysts such as platinum have disadvantages in terms of cost and resources, which probably hinder the spread of cation exchange membranes. Therefore, in order to reduce the cost of catalysts, the use of anion exchange membranes as ion exchange membranes has been studied to allow the use of various metals as catalysts. Examples of anion exchange membranes for this application have also been reported.

For example, JP 2000-331693 A discloses a production method including a step of radiation graft-polymerizing a monomer containing an anion exchange group or a functional group into which an anion exchange group can be introduced, onto a substrate made of a fluorine-containing polymer. JP 2000-331693 A describes that an anion exchange membrane containing an anion exchange group can be obtained by this method. JP 2010-516853 T discloses a method for producing an anion exchange membrane, including the steps of; radiation grafting a hydrocarbon polymer film with a monomer; and adding a quaternizing agent to impart ionic conductivity.

However, the studies of the present inventors have revealed that when the membranes obtained by these production methods are exposed to an environment (heating conditions at 80° C. in the presence of alkali (KOH)) to which they are presumably exposed in an anion exchange membrane fuel cell, grafted chains are degraded and separated from the membrane in a short time, resulting in loss of anionic conductivity. The studies have also revealed that the degradation and separation of grafted chains cause changes in the appearance and structure of the membranes. Therefore, it is difficult to obtain highly durable anion exchange membrane fuel cells even if the above-described anion exchange membranes are used.

### CITATION LIST

### Patent Literature

Patent Literature 1: JP 2000-331693 A

Patent Literature 2: JP 2010-516853 T

### SUMMARY OF INVENTION

### Technical Problem

Under these circumstances, one of the objects of the present invention is to provide a novel anion exchange membrane having higher durability, a method for producing the same, and a fuel cell using the same.

### Solution to Problem

In order to achieve the above object, the present invention provides a method for producing an anion exchange membrane. This production method includes the steps of: (i) irradiating a first polymer film with radiation; and (ii) graft-polymerizing a monomer containing a site into which a functional group having anion conducting ability can be introduced and an unsaturated carbon-carbon bond onto the radiation-irradiated first polymer film so as to form a second polymer film containing grafted chains. This method further includes the subsequent steps of: (a) subjecting the second polymer film to a treatment including irradiation with radiation so as to introduce a crosslinked structure into the grafted chains; and (b) introducing the functional group having anion conducting ability into the site.

The anion exchange membrane produced by the production method of the present invention constitutes an example of the anion exchange membrane of the present invention. The fuel cell of the present invention is a fuel cell including a membrane-electrode assembly including an anion exchange membrane. This anion exchange membrane is the anion exchange membrane produced by the production method of the present invention.

### Advantageous Effects of Invention

According to the production method of the present invention, a crosslinked structure is introduced into grafted chains, and thus the degradation and separation of the grafted chains are suppressed. In addition, changes in the appearance and structure of the membrane are also suppressed. Therefore, according to the present invention, it is possible to obtain a highly durable anion exchange membrane. The use of the anion exchange membrane obtained by the present invention makes it possible to form a highly durable membrane-electrode assembly or a highly durable fuel cell.

### BRIEF DESCRIPTION OF DRAWINGS

FIG. 1 is a cross-sectional SEM image of an anion exchange membrane of Example 3 after 500-hour immersion in an aqueous KOH solution.

FIG. 2 is a cross-sectional SEM image of an anion exchange membrane of Comparative Example 3 after 500-hour immersion in an aqueous KOH solution.

### DESCRIPTION OF EMBODIMENTS

Embodiments of the present invention will be described below. In the following description, the embodiments of the present invention are described by way of examples, but the present invention is not limited to the examples described below. In the following description, specific numerical values and materials may be shown as examples, but other numerical values and materials may be used as long as the effects of the present invention can be obtained. Compounds described below may be used alone or in combination with other compounds, unless otherwise specified.

(Production Method of Anion Exchange Membrane)

The method of the present invention for producing an anion exchange membrane includes the steps (i) and (ii) described below in this order, and further includes the subsequent steps (a) and (b) described below. The step (b) may be performed before or after the step (a). Either the step (a) or the step (b) may be performed first.

In the step (i), a first polymer film (substrate) is irradiated with radiation. As a resin constituting the first polymer film, a resin that can be subjected to radiation-induced graft polymerization is used. Preferably, the resin constituting the first polymer film contains at least one selected from the group consisting of aromatic hydrocarbon polymers, olefin polymers (non-fluorinated olefin polymers), and fluorinated olefin polymers because of their electrochemical stability, mechanical strength, etc.

Examples of aromatic hydrocarbon polymers include polystyrene, polyethylene terephthalate, polybutylene terephthalate, polytrimethylene terephthalate, polyethylene naphthalate, polybutylene naphthalate, polyetheretherketone, polyetherketone, polysulfone, polyether sulfone, polyphenylene sulfide, polyarylate, polyetherimide, aromatic polyimide, and polyamideimide.

Examples of olefin polymers include polyethylene (PE) such as low-density polyethylene, high-density polyethylene, or ultrahigh molecular weight polyethylene, polypropylene (PP), polybutene, and polymethylpentene.

Examples of fluorinated olefin polymers include polyvinylidene fluoride (PVDF), polyvinyl fluoride, ethylene-tetrafluoroethylene copolymer (ETFE), vinylidene fluoride-hexafluoropropylene copolymer (FEP), tetrafluoroethylene-hexafluoropropylene copolymer, polytetrafluoroethylene, crosslinked polytetrafluoroethylene (PTFE), tetrafluoroethylene-perfluoroalkyl vinyl ether copolymer (PFA), polychlorotrifluoroethylene, tetrafluoroethylene-hexafluoropropylene-vinylidene fluoride copolymer.

Among these, preferably, the resin (polymer) constituting the first polymer film contains at least one selected from the group consisting of polystyrene, polyetheretherketone, polyetherketone, polysulfone, polyether sulfone, polyphenylene sulfide, polyarylate, polyetherimide, aromatic polyimide, polyamideimide, polyethylene, polypropylene, polyvinylidene fluoride, polyvinyl fluoride, ethylene-tetrafluoroethylene copolymer, vinylidene fluoride-hexafluoropropylene copolymer, crosslinked polytetrafluoroethylene, tetrafluoroethylene-perfluoroalkyl vinyl ether copolymer, and tetrafluoroethylene-hexafluoropropylene-vinylidene fluoride copolymer. The resin constituting the first polymer film may be a copolymer or a mixture of two or more polymers.

The first polymer film may be formed by any technique such as casting, cutting of a sintered body, kneading and molding, or the like. Any of these techniques and any stretching technique (for example, uniaxial stretching, simultaneous biaxial stretching, sequential biaxial stretching, or the like) may be combined to form the film. When a polymer film produced by a stretching-combined technique is used as a substrate, the effect of inhibiting the swelling of the film in water and the effect of improving the durability of the film under fuel, radical, and alkali conditions can be obtained.

One of the important properties of an electrolyte membrane is a low membrane resistance. It is preferable to reduce the membrane thickness to reduce the membrane resistance. However, when the membrane thickness is reduced too much, the strength of the membrane decreases and the membrane is more likely to experience problems including increased susceptibility to defects such as pinholes. Therefore, the thickness of the electrolyte membrane is preferably in a range of 6 μm to 130 μm, and more preferably in a range of 12 μm to 70 μm. The thickness of the first polymer film serving as the substrate tends to increase in the graft polymerization step and the anion exchange group introduction step. Therefore, the thickness of the first polymer film is preferably in a range of 5 μm to 100 μm, and more preferably in a range of 10 μm to 50 μm.

Ionizing radiation, for example, α rays, β rays, γ rays, electron beams, and ultraviolet rays may be used as the radiation to which the first polymer film is exposed. Usually, γ rays or electron beams are preferably used. The radiation dose is preferably in a range of 1 kGy to 400 kGy, and more preferably in a range of 10 kGy to 300 kGy. The radiation dose of 1 kGy or more prevents the grafting ratio of the resulting film from becoming too low. The radiation dose of 400 kGy or less suppresses excessive polymerization reaction, deterioration of the resin, etc.

The radiation-irradiated polymer film may be maintained at a low temperature (for example, −30° C. or lower) until the next step is performed.

In the next step (ii), a monomer containing a site into which a functional group having anion conducting ability can be introduced and an unsaturated carbon-carbon bond are graft-polymerized onto the radiation-irradiated first polymer film so as to form a second polymer film containing grafted chains. Hereinafter, the monomer used in the step (ii) may be referred to as a vinyl monomer (M). In a preferred example, the graft polymerization reaction is carried out in a solid-liquid two-phase system. For example, it is preferable to carry out the graft polymerization by bringing the radiation-irradiated first polymer film into contact with a liquid containing the vinyl monomer (M). It is preferable to carry out the graft polymerization in an atmosphere with the lowest oxygen concentration possible in order to prevent the reaction from being inhibited by the presence of oxygen. For example, the liquid containing the vinyl monomer (M) may be bubbled with nitrogen gas or the like.

The weight (dry weight) of the second polymer film may be in a range of 1.3 to 4.0 times the weight (dry weight) of the first polymer film (i.e., 30 to 300% in terms of grafting ratio). For example, the weight of the second polymer film may be in a range of 1.4 to 3.5 times the weight of the first polymer film (i.e., 40 to 250% in terms of grafting ratio), or 1.5 to 3.5 times (i.e., 50 to 250% in terms of grafting ratio). When the weight of the second polymer film is at least 1.3 times the weight of the first polymer film, a sufficient amount of functional groups having anion conducting ability can be introduced and therefore sufficient anionic conductivity can be obtained. When the weight of the second polymer film is not more than 4.0 times, a decrease in the strength of the resulting second polymer film, which leads to embrittlement thereof, can be suppressed.

The unsaturated carbon-carbon bond (for example, a carbon-carbon double bond, such as a vinyl group) contained in the vinyl monomer (M) is a group for graft polymerization. The vinyl monomer (M) may contain a benzene ring (such as a phenylene group) serving as a resonance-stabilized structure to improve polymerizability.

The vinyl monomer (M) further contains a site into which a functional group having anion conducting ability can be introduced. Therefore, a grafted chain formed using the vinyl monomer (M) contains the site into which a functional group having anion conducting ability can be introduced. Examples of such a site include a halogenated alkyl group. A halogenated alkyl group can form a quaternary ammonium salt group when it reacts with trialkylamine.

The preferred vinyl monomer (M) includes a unsaturated carbon-carbon bond (for example, a vinyl group) and a halogenated alkyl group. Examples of the halogenated alkyl group include a halogenated methyl group, a halogenated ethyl group, a halogenated propyl group, and a halogenated butyl group, and examples of halogens contained in these groups include chlorine, bromine, fluorine, and iodine.

Preferred examples of the vinyl monomer (M) include halogenated alkylstyrene containing a halogenated alkyl group. Examples of halogenated alkylstyrene include chloromethylstyrene, chloroethylstyrene, chloropropylstyrene, chlorobutylstyrene, bromomethylstyrene, bromoethylstyrene, bromopropylstyrene, bromobutylstyrene, iodomethylstyrene, iodoethylstyrene, iodopropylstyrene, and iodobutylstyrene. The positional relationship between the halogenated alkyl group and the vinyl group in the halogenated alkylstyrene is not particularly limited as long as the method of the present invention can be carried out. They may be in the meta and/or para position, and for example, they are in the para position.

Other examples of the vinyl monomer (M) include halogenated alkyl vinyl ketone (X—R—C(═O)—CH═CH₂) and (halogenated alkyl)acrylamide (X—R—NH—C(═O)—CH═CH₂). “X—R—” represents a halogenated alkyl group.

Preferably, the vinyl monomer (M) has a structure into which a crosslinked structure can be easily introduced in the step (a) described below. In a preferred example, the site into which a functional group having anion conducting ability can be introduced serves to facilitate introduction of the crosslinked structure. Examples of such a site include a halogenated alkyl group. Presumably, the presence of a halogenated alkyl group in a grafted chain facilitates introduction of the crosslinked structure.

As the monomer, one type of vinyl monomer (M) may be used alone, or two or more types of vinyl monomers (M) may be used in combination. When two or more types of vinyl monomers (M) are used in combination as the monomer, grafted chains are formed by copolymerization of these vinyl monomers (M).

As a solvent used to dissolve the vinyl monomer (M), any solvent in which the vinyl monomer (M) is soluble but the polymer film (substrate) is substantially insoluble is selected. The solvent is not particularly limited. Aromatic compounds such as: aromatic hydrocarbons including benzene, toluene, and xylene and phenols including phenol and cresol may be used. When an aromatic compound is used as the solvent, a high graft polymerization rate can be achieved. In addition, since the aromatic compound dissolves a homopolymer as a by-product, the polymerization mixture can be kept homogeneous. The solubilities of the monomer and the polymer film in the solvent may vary depending on the structures, polarities, etc. of the monomer and the resin material. Therefore, the solvent can be selected as appropriate according to the solubilities of the monomer and the resin material used. A mixture of two or more compounds may be used as the solvent. In the case where the vinyl monomer (M) is a liquid at a temperature at which graft polymerization is to be carried out, graft polymerization may be carried out without using a solvent.

The concentration of the monomer in the monomer solution is determined according to the polymerizability of the monomer and the target grafting ratio, but usually it is preferably 20 wt. % or more. The monomer concentration of 20 wt. % or more prevents insufficient grafting reaction.

An example of the graft polymerization is carried out in a solid-liquid two-phase system, as described below. First, the monomer solution is poured into a vessel of glass, stainless steel, or the like. Next, in order to remove dissolved oxygen, which inhibits the grafting reaction, the monomer solution is degassed under reduced pressure and bubbled with an inert gas (such as nitrogen gas).

Then, the radiation-irradiated first polymer film is put into the monomer solution to carry out graft polymerization. Grafted chains are attached to the polymer constituting the first polymer film through the graft polymerization. The reaction time of the graft polymerization is, for example, about 10 minutes to 12 hours. The reaction temperature is, for example, 0 to 100° C. (preferably 40 to 80° C.).

Next, the second polymer film containing grafted chains is removed from the reaction solution and filtered. Then, in order to remove the solvent, unreacted monomer, and homopolymer of the monomer, the second polymer film is washed 3 to 6 times with an appropriate amount of dissolving agent, followed by drying. As the dissolving agent, any dissolving agent in which the monomer and the homopolymer are readily soluble but the second polymer film (containing grafted chains) is substantially insoluble can be used. For example, toluene, acetone, or the like may be used as the dissolving agent.

In the step (a), the second polymer film is subjected to a treatment including irradiation with radiation so as to introduce a crosslinked structure into the grafted chains. The step (a) may further include a treatment of heating the second polymer film simultaneously with or after the irradiation with radiation. The crosslinked structure can be introduced efficiently by the heat treatment. A preferred example of the step (a) includes a treatment of heating the second polymer film after the irradiation with radiation. When halogenated alkylstyrene is used as the monomer for graft polymerization, halogen radicals are likely to be released from the grafted chains and stabilized in the form of radicals at the time of irradiation with radiation. This is probably why the crosslinked structure is efficiently introduced between the grafted chains by the heat treatment after the irradiation with radiation.

The timing of the crosslinking reaction step by these radiation irradiation and heat treatment is very important. For example, if the crosslinking reaction step is performed before the graft polymerization step, the crosslinked structure is not introduced into the grafted chains but only the polymer constituting the substrate is crosslinked, and therefore the effect of improving the durability of the grafted chains cannot be obtained sufficiently.

When a graft-polymerized membrane in which the polymer constituting the substrate and the grafted chains are dispersed very finely is subjected to the crosslinking treatment, it is expected that the crosslinked structure is formed not only between the grafted chains but also between the polymer constituting the substrate and the grafted chains. In this case, therefore, the durability is expected to be further improved.

The radiation irradiated in the step (a) can be selected from the radiations described as examples of the radiation used in the step (i), and usually γ rays or electron beams are preferred. The radiation dose is preferably in a range of 10 kGy to 1600 kGy, and more preferably in a range of 100 kGy to 800 kGy. The radiation dose of 10 kGy or more prevents insufficient crosslinking reaction. The radiation dose of 1600 kGy or less prevents excessive crosslinking reaction, deterioration of the resin, etc.

In the case where the step (a) includes the treatment of heating the second polymer film during or after the irradiation with radiation, the heat treatment is performed under the conditions in which the second polymer film is insoluble and radicals are reactive. For example, the heat treatment may be performed at temperatures ranging from 60° C. to 140° C. for 30 minutes to 2 hours. In the production method of the present invention, both the graft polymerization and the introduction of the crosslinked structure are performed by irradiation with radiation. Therefore, the production method of the present invention is advantageous in terms of production efficiency and cost in some cases.

In the step (b), a functional group (anion exchange group) having anion conducting ability is introduced into a site of a grafted chain into which a functional group having anion conducting ability can be introduced. For example, in the case where the site is a halogenated alkyl group (for example, a chloromethyl group), quaternization treatment may be carried out using amine (for example, trialkylamine) so as to introduce an anion exchange group (quaternary ammonium salt group) into the grafted chain. Examples of the amines include trialkylamines such as trimethylamine, triethylamine, and dibutylmethylamine, diamines such as ethylenediamine, and aromatic amines such as pyridine and imidazole.

An anion exchange membrane is obtained by the step (b). The membrane that has passed through the step (b) is washed with alcohol, acid, pure water, or the like, if necessary.

In a preferred example of the production method of the present invention, the first polymer film is made of at least one selected from the group consisting of ethylene-tetrafluoroethylene copolymer, high-density polyethylene, and ultrahigh molecular weight polyethylene, and the vinyl monomer (M) is halogenated alkylstyrene. In a preferred example in this case, the halogenated alkylstyrene is chloromethylstyrene.

(Anion Exchange Membrane and Fuel Cell)

The anion exchange membrane of the present invention includes a film formed of a polymer, and grafted chains are attached to the polymer. Since the anion exchange membrane of the present invention is produced by the production method of the present invention described above, the same description is not repeated. For example, since the film, the polymer forming the film, and the grafted chains attached to the polymer are described above, the same description is not repeated. In this anion exchange membrane, a crosslinked structure is introduced into the grafted chains and thus at least the grafted chains are crosslinked. Therefore, when the anion exchange membrane is used as an electrolyte for use in an anion exchange membrane fuel cell, the degradation of the grafted chains and separation thereof from the membrane are inhibited. Thus, according to the present invention, it is possible to obtain a highly durable anion exchange membrane.

The fuel cell of the present invention includes a membrane-electrode assembly including an anion exchange membrane as a solid electrolyte, and the anion exchange membrane is the anion exchange membrane produced by the production method of the present invention. There is no particular limitation on the components other than the anion exchange membrane, and for example, a known configuration can be used.

### EXAMPLES

Hereinafter, the present invention will be described in more detail by way of examples.

### Example 1

In Example 1, a 8-cm square film (with a thickness of 50 μm) made of ethylene-tetrafluoroethylene copolymer (ETFE) was used as a substrate (first polymer film). Both sides of this ETFE film were irradiated with an electron beam at room temperature in a vacuum. Each side of the film was irradiated with an electron beam of 30 kGy (60 kGy in total) under the condition of an accelerating voltage of 60 kV. After the electron beam irradiation, the ETFE film was cooled to dry ice temperature using dry ice and stored until the next step was performed.

Next, 28 g of 4-(chloromethyl)styrene as a monomer and 12 g of xylene were mixed together to prepare a monomer solution. Next, this monomer solution was bubbled with nitrogen gas to remove oxygen in the monomer solution. The electron beam-irradiated substrate was immersed in the resulting monomer solution at 70° C. for 2 hours so as to allow graft polymerization to proceed. Next, the graft-polymerized film was taken out of the reaction solution, and immersed and washed in toluene for at least one hour and then further washed with acetone for 30 minutes. After the washing, the film was dried in a dryer at 60° C. Thus, a graft membrane G-1 (second polymer film) was obtained. The grafting ratio of the graft membrane thus obtained was 61%.

Next, both sides of this graft membrane G-1 were irradiated with an electron beam at room temperature in a vacuum. Each side of the membrane was irradiated with an electron beam of 240 kGy (480 kGy in total) under the condition of an accelerating voltage of 60 kV. After the electron beam irradiation, the graft membrane was cooled to dry ice temperature using dry ice and stored until the next step was performed. Next, the electron beam-irradiated graft membrane was subjected to heat treatment in a dryer at 140° C. for one hour so as to allow a crosslinking reaction to proceed.

After the crosslinking reaction, the above graft membrane was immersed in an ethanol solution of dimethylbutylamine (with a concentration of 30 wt. %, manufactured by Aldrich) at room temperature for 24 hours so as to perform quaternization treatment of chloromethyl groups. After the quaternization treatment, the graft membrane was washed with ethanol for 30 minutes. Then, the graft membrane was washed with 1N HCl-ethanol solution for 30 minutes and further washed with pure water. Thus, an anion exchange membrane A-1 including an ETFE film as a substrate and having quaternary ammonium salt groups containing chloride ions was obtained.

### Example 2

In Example 2, a 8-cm square film (with a thickness of 50 μm) made of high-density polyethylene (HDPE) was used as a substrate (first polymer film). Both sides of this HDPE film were irradiated with an electron beam at room temperature in a vacuum. Each side of the film was irradiated with an electron beam of 30 kGy (60 kGy in total) under the condition of an accelerating voltage of 60 kV. After the electron beam irradiation, the HDPE film was cooled to dry ice temperature using dry ice and stored until the next step was performed.

Next, 40 g of 4-(chloromethyl)styrene was put into a reaction vessel, and oxygen in the system was removed by replacement with nitrogen. The electron beam-irradiated substrate was immersed in the resulting 4-(chloromethyl)styrene at 50° C. for 15 hours to allow graft polymerization to proceed. Next, the graft-polymerized film was taken out of the reaction solution, and immersed and washed in toluene for at least one hour and then further washed with acetone for 30 minutes. After the washing, the film was dried in a dryer at 60° C. Thus, a graft membrane G-2 (second polymer film) was obtained. The grafting ratio of the graft membrane thus obtained was 92%.

Next, both sides of this graft membrane G-2 were irradiated with an electron beam at room temperature in a vacuum. Each side of the membrane was irradiated with an electron beam of 240 kGy (480 kGy in total) under the condition of an accelerating voltage of 60 kV. After the electron beam irradiation, the graft membrane was cooled to dry ice temperature using dry ice and stored until the next step was performed. Next, the electron beam-irradiated graft membrane was subjected to heat treatment in a dryer at 80° C. for one hour so as to allow a crosslinking reaction to proceed.

After the crosslinking reaction, the graft membrane was subjected to quaternization treatment of chloromethyl groups and washing in the same manner as in Example 1. Thus, an anion exchange membrane A-2 including a HDPE film as a substrate and having quaternary ammonium salt groups containing chloride ions was obtained.

### Example 3

In Example 3, a 8-cm square film (with a thickness of 30 μm) obtained by stretching an ultrahigh molecular weight polyethylene (UHMWPE) film to 5 times its original length in the MD direction (machine direction) and to 5 times its original width in the TD direction (transverse direction) was used as a substrate (first polymer film). Both sides of this UHMWPE film were irradiated with an electron beam at room temperature in a vacuum. Each side of the film was irradiated with an electron beam of 90 kGy (180 kGy in total) under the condition of an accelerating voltage of 60 kV. After the electron beam irradiation, the UHMWPE film was cooled to dry ice temperature using dry ice and stored until the next step was performed.

Next, 40 g of 4-(chloromethyl)styrene was put into a reaction vessel, and oxygen in the system was removed by replacement with nitrogen. The electron beam-irradiated substrate was immersed in the resulting 4-(chloromethyl)styrene at 50° C. for 15 hours to allow graft polymerization to proceed. Next, after the graft polymerization, the film was taken out of the reaction solution, and immersed and washed in toluene for at least one hour and then further washed with acetone for 30 minutes. After the washing, the film was dried in a dryer at 60° C. Thus, a graft membrane G-3 (second polymer film) was obtained. The grafting ratio of the graft membrane thus obtained was 240%.

Next, both sides of this graft membrane G-3 were irradiated with an electron beam at room temperature in a vacuum. Each side of the membrane was irradiated with an electron beam of 240 kGy (480 kGy in total) under the condition of an accelerating voltage of 60 kV. After the electron beam irradiation, the graft membrane was cooled to dry ice temperature using dry ice and stored until the next step was performed. Next, the electron beam-irradiated graft membrane was subjected to heat treatment in a dryer at 80° C. for one hour so as to allow a crosslinking reaction to proceed.

After the crosslinking reaction, the graft membrane was subjected to quaternization treatment of chloromethyl groups and washing in the same manner as in Example 1. Thus, an anion exchange membrane A-3 including an UHMWPE film as a substrate and having quaternary ammonium salt groups containing chloride ions was obtained.

### Example 4

In Example 4, the graft membrane G-3 described in Example 3 was subjected to quaternization treatment of chloromethyl groups and washing in the same manner as in Example 1.

Next, both sides of the quaternized anion exchange membrane were irradiated with an electron beam at room temperature in a vacuum. Each side of the film was irradiated with an electron beam of 720 kGy (1440 kGy in total) under the condition of an accelerating voltage of 60 kV. After the electron beam irradiation, the graft membrane was cooled to dry ice temperature using dry ice and stored until the next step was performed. Next, the electron beam-irradiated graft membrane was subjected to heat treatment in a dryer at 80° C. for one hour so as to allow a crosslinking reaction to proceed. Thus, an anion exchange membrane A-4 including an UHMWPE film as a substrate and having quaternary ammonium salt groups containing chloride ions was obtained.

### Example 5

In Example 5, a 5-cm square film (with a thickness of 50 μm) made of high-density polyethylene (HDPE) was used as a substrate (first polymer film). Both sides of this HDPE film were irradiated with an electron beam at room temperature in a vacuum. Each side of the film was irradiated with an electron beam of 200 kGy (400 kGy in total) under the condition of an accelerating voltage of 60 kV. After the electron beam irradiation, the HDPE film was cooled to dry ice temperature using dry ice and stored until the next step was performed.

Next, 40 g of 4-(4-bromobutyl)styrene was put into a reaction vessel, and oxygen in the system was removed by replacement with nitrogen. The electron beam-irradiated sample was immersed in the resulting 4-(4-bromobutyl)styrene at 70° C. for 7 hours to allow graft polymerization to proceed. Next, after the graft polymerization, the film was taken out of the reaction solution, and immersed and washed in toluene for at least one hour and then further washed with acetone for 30 minutes. After the washing, the film was dried in a dryer at 60° C. Thus, a graft membrane G-5 (second polymer film) was obtained. The grafting ratio of the graft membrane thus obtained was 120%.

Next, both sides of this graft membrane G-5 were irradiated with an electron beam at room temperature in a vacuum. Each side of the membrane was irradiated with an electron beam of 240 kGy (480 kGy in total) under the condition of an accelerating voltage of 60 kV. After the electron beam irradiation, the graft membrane was cooled to dry ice temperature using dry ice and stored until the next step was performed. Next, the electron beam-irradiated graft membrane was subjected to heat treatment in a dryer at 80° C. for one hour so as to allow a crosslinking reaction to proceed.

Next, the above crosslinked graft membrane was immersed in an ethanol solution of dimethylbutylamine (with a concentration of 60 wt. %, manufactured by Aldrich) at 60° C. for 20 hours so as to perform quaternization treatment of bromobutyl groups. After the quaternization treatment, the graft membrane was washed with ethanol for 30 minutes. Then, the graft membrane was washed with 1N HCl-ethanol solution for 90 minutes and further washed with pure water. At this point in time, counter anions were exchanged and bromide ions were replaced by chloride ions. Thus, an anion exchange membrane A-5 including a HDPE film as a substrate and having quaternary ammonium salt groups containing chloride ions was obtained.

### Comparative Example 1

In Comparative Example 1, as in Example 1, a 8-cm square film (with a thickness of 50 μm) made of ethylene-tetrafluoroethylene copolymer (ETFE) was used as a polymer substrate. A graft membrane G-1 having a grafting ratio of 61% was produced using this ETFE film in the same manner as in Example 1.

The graft membrane G-1 was subjected to quaternization treatment of chloromethyl groups without being subjected to crosslinking treatment. The quaternization treatment was performed under the same conditions as in Example 1. Thus, an anion exchange membrane A-C1 including an ETFE film as a substrate and having quaternary ammonium salt groups containing chloride ions was obtained.

### Comparative Example 2

In Comparative Example 2, as in Example 2, a 8-cm square film (with a thickness of 50 μm) made of high-density polyethylene (HDPE) was used as a polymer substrate. Both sides of this HDPE film were irradiated with an electron beam at room temperature in a vacuum. Each side of the film was irradiated with an electron beam of 30 kGy (60 kGy in total) under the condition of an accelerating voltage of 60 kV. After the electron beam irradiation, the HDPE film was cooled to dry ice temperature using dry ice and stored until the next step was performed.

Next, 40 g of 4-(chloromethyl)styrene was put into a reaction vessel, and oxygen in the system was removed by replacement with nitrogen. The electron beam-irradiated sample was immersed in the resulting 4-(chloromethyl)styrene at 70° C. for 2 hours to allow graft polymerization to proceed. Next, after the graft polymerization, the film was taken out of the reaction solution, and immersed and washed in toluene for at least one hour and then further washed with acetone for 30 minutes. After the washing, the film was dried in a dryer at 60° C. Thus, a graft membrane G-C2 was obtained. The grafting ratio of the graft membrane thus obtained was 80%.

The above graft membrane G-C2 was subjected to quaternization treatment of chloromethyl groups and washing in the same manner as in Example 1, without being subjected to crosslinking treatment. Thus, an anion exchange membrane A-C2 including a HDPE film as a substrate and having quaternary ammonium salt groups containing chloride ions was obtained.

### Comparative Example 3

In Comparative Example 3, as in Example 3, a 8-cm square film (with a thickness of 50 μm) obtained by stretching an ultrahigh molecular weight polyethylene (UHMWPE) film to 5 times its original length in the machine direction and to 5 times its original width in the transverse direction was used as a polymer substrate. Both sides of this UHMWPE film were irradiated with an electron beam at room temperature in a vacuum. Each side of the film was irradiated with an electron beam of 90 kGy (180 kGy in total) under the condition of an accelerating voltage of 60 kV. After the electron beam irradiation, the UHMWPE film was cooled to dry ice temperature using dry ice and stored until the next step was performed.

Next, 40 g of 4-(chloromethyl)styrene was put into a reaction vessel, and oxygen in the system was removed by replacement with nitrogen. The electron beam-irradiated sample was immersed in the resulting 4-(chloromethyl)styrene at 70° C. for 2 hours to allow graft polymerization to proceed. Next, after the graft polymerization, the film was taken out of the reaction solution, and immersed and washed in toluene for at least one hour and then further washed with acetone for 30 minutes. After the washing, the film was dried in a dryer at 60° C. Thus, a graft membrane G-C3 was obtained. The grafting ratio of the graft membrane thus obtained was 240%.

The above graft membrane G-C3 was subjected to quaternization treatment of chloromethyl groups and washing in the same manner as in Example 1, without being subjected to crosslinking treatment. Thus, an anion exchange membrane A-C3 including an UHMWPE film as a substrate and having quaternary ammonium salt groups containing chloride ions was obtained.

### Comparative Example 4

In Comparative Example 4, as in Example 5, a 8-cm square film (with a thickness of 50 μm) made of high-density polyethylene (HDPE) was used as a polymer substrate. A graft membrane G-C4 having a grafting ratio of 120% was produced using this HDPE film in the same manner as in Example 5.

The graft membrane G-C4 was subjected to quaternization treatment of buromobutyl groups without being subjected to crosslinking treatment. The quaternization treatment was performed under the same conditions as in Example 5. Thus, an anion exchange membrane A-C4 including a HDPE film as a substrate and having quaternary ammonium salt groups containing chloride ions was obtained.

(Measurement of Ionic Conductivity)

For each of the anion exchange membranes of Examples and Comparative Examples, the ionic conductivity was measured in the following manner. First, each membrane was immersed in water (at a temperature of 25° C.) for at least one hour to be swollen. Next, a platinum foil electrode (with a width of 10 mm) was placed on each principal surface of the swollen membrane to produce a specimen for measuring the ionic conductivity. In producing the specimen, the two platinum foil electrodes were displaced from each other by a distance of 10 mm.

For each of the above specimens, the impedance was measured using an LCR meter. The measurement was performed at frequencies ranging from 10 kHz to 1 MHz. For the impedance thus obtained, the real part was plotted on the horizontal axis and the imaginary part was plotted on the vertical axis, and the value of the real part of the impedance at the lowest frequency was defined as a membrane resistance R (Ω). The ionic conductivity σ [S/cm] was calculated from the following equation:

σ=L/(R×t×h×10⁻⁴)

where t [μm] is the thickness of the swollen membrane, h [cm] is the width of the sample, L [cm] is the distance between the electrodes placed.

(Evaluation of Membrane Durability in Aqueous KOH Solution)

For each of the anion exchange membranes of Examples and Comparative Examples, the durability in a high temperature aqueous alkaline solution was evaluated in the following manner. First, each anion exchange membrane was cut into a rectangular piece of about 3 cm×4 cm to obtain a measurement sample. This sample was dried in a dryer at 60° C. for at least 2 hours, and then the weight of the dried sample (weight before the KOH treatment) was measured. This sample was immersed in 1N aqueous KOH solution (80° C.) for 180 hours or 500 hours (this treatment is sometimes referred to simply as “KOH treatment”). After this immersion treatment, the sample was taken out of the aqueous KOH solution and washed with pure water two or more times. Next, the sample was immersed in saturated salt solution at room temperature for at least 3 hours. Next, the sample was further washed two or more times, and then dried in a dryer at 60° C. Then, the weight of the dried sample (weight after the KOH treatment) was measured. The weight retention rate (%) of the grafted chains was calculated from the following equation using the measured value and the grafting ratio (%) after the graft polymerization.

Weight retention rate (%) of grafted chains=(Weight of grafted chains after KOH treatment)×100/(Weight of grafted chains before KOH treatment)

where

Weight of grafted chains before KOH treatment=(Weight before KOH treatment)×(Grafting ratio after quaternization)/(100+(Grafting ratio after quaternization))

Weight of grafted chains after KOH treatment=(Weight after KOH treatment)−{(Weight before KOH treatment)×100/(100+(Grafting ratio after quaternization))}

Grafting ratio (%) after quaternization=(Grafting ratio after graft polymerization)×(Molecular weight of unit structure after quaternization)/(Molecular weight of monomer)

The anion exchange membranes of Examples 3 and 4 and Comparative Example 3 were subjected to the KOH treatment for 500 hours and then to visual observation and SEM observation. Table 1 and Table 2 show the production conditions and evaluation results of the anion exchange membranes of Examples and Comparative Examples. In these tables, “CMS” represents 4-(chloromethyl)styrene and “BBS” represents 4-(4-bromobutyl)styrene. In the column “crosslinking treatment”, “after grafting” means that the crosslinking treatment was performed after grafting but before quaternization treatment. In these tables, “-” indicates that neither measurement nor evaluation was performed.

The grafting ratio in Table 1 (grafting ratio in the step (ii)) was calculated from the following equation.

Grafting ratio (%) in Step (ii)=100×{(Weight of membrane after graft polymerization)−(Weight of membrane before graft polymerization)}/(Weight of membrane before graft polymerization)

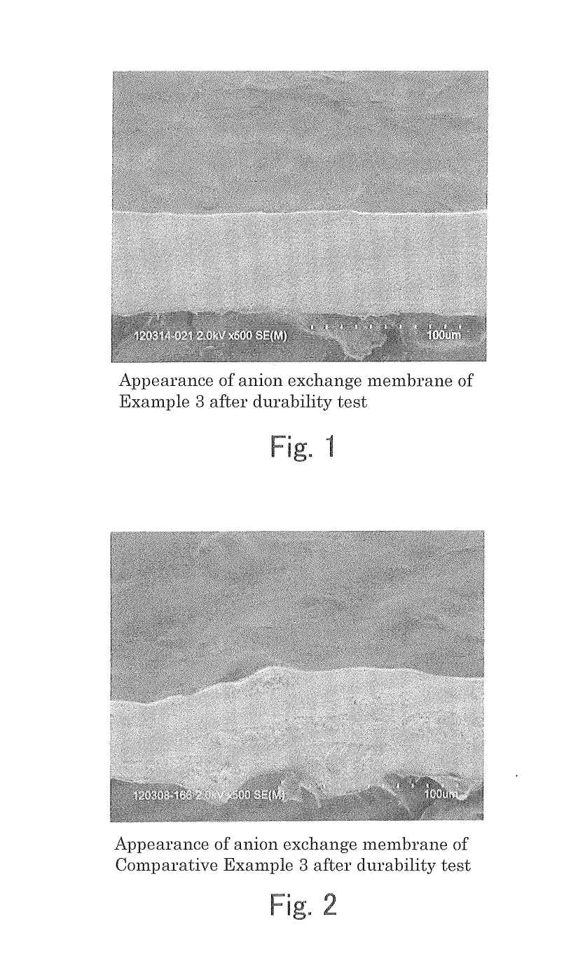

TABLE 1

| | Example | Example | Example | Example | Example |
|---|---|---|---|---|---|
| | 1 | 2 | 3 | 4 | 5 |
| Polymer | ETFE | HDPE | UHMWPE | UHMWPE | HDPE |
| constituting | | | | | |
| substrate | | | | | |
| Monomer | CMS | CMS | CMS | CMS | BBS |
| Crosslinking | After | After | After | After | After |
| treatment | grafting | grafting | grafting | quaterni- | grafting |
| | | | | zation | |
| Grafting ratio | 61 | 92 | 240 | 240 | 120 |
| [%] | | | | | |
| Ionic | 23 | 35 | 15 | 15 | 19 |
| conductivity | | | | | |
| [mS/cm] | | | | | |
| Weight | 92 | 84 | — | — | 99 |
| retention rate | | | | | |
| of grafted | | | | | |
| chains [%] (180 | | | | | |
| hours after | | | | | |
| KOH treatment) | | | | | |
| Weight | — | — | 92 | 93 | 94 |
| retention | | | | | |
| rate [%] of | | | | | |
| grafted chains | | | | | |
| (500 hours after | | | | | |
| KOH treatment) | | | | | |
| Appearance | — | — | Unchanged | Good | — |
| after durability | | | (FIG. 1) | | |
| test (500 hours | | | | | |
| after KOH | | | | | |
| treatment) | | | | | |

TABLE 2

| | Com- | Com- | Com- | Com- |
|---|---|---|---|---|
| | parative | parative | parative | parative |
| | Example 1 | Example 2 | Example 3 | Example 4 |
| Polymer | ETFE | HDPE | UHMWPE | HDPE |
| constituting | | | | |
| substrate | | | | |
| Monomer | CMS | CMS | CMS | BBS |
| Crosslinking | Not | Not | Not | Not |
| treatment | performed | performed | performed | performed |
| Grafting ratio [%] | 61 | 80 | 240 | 120 |
| Ionic conductivity | 23 | 29 | 23 | 20 |
| [mS/cm] | | | | |
| Weight retention | 53 | 58 | — | 96 |
| rate of grafted | | | | |
| chains [%] | | | | |
| (180 hours after | | | | |
| KOH treatment) | | | | |
| Weight retention | — | — | 83 | 90 |
| rate of grafted | | | | |
| chains [%] | | | | |
| (500 hours after | | | | |
| KOH treatment) | | | | |
| Appearance after | — | — | Poor | — |
| durability test | | | appearance | |
| (500 hours after | | | (bumps were | |
| KOH treatment) | | | observed) | |
| | | | (FIG. 2) | |

As shown in Tables 1 and 2, the durability in the aqueous KOH solution of the membrane of Example 1, which was subjected to the crosslinking treatment, was higher than that of the membrane of Comparative Example 1, which was produced under the same conditions as in Example 1 except that the membrane of Comparative Example 1 was not subjected to the crosslinking treatment. Likewise, the durability in the aqueous KOH solution of the membranes of Examples 3, 4 and 5 was higher than that of the membranes of Comparative Examples 3 and 4, which were produced under the same conditions as in Examples 3, 4 and 5 except that the membranes of Comparative Examples 3 and 4 were not subjected to the crosslinking treatment.

Furthermore, the appearance of the membranes of Examples 3 and 4, which were treated with the aqueous KOH solution after being subjected to the crosslinking treatment, was better than that of the membrane of Comparative Example 3, which was treated with the aqueous KOH solution without being subjected to the crosslinking treatment. FIG. 1 and FIG. 2 show the SEM images of the anion exchange membranes of Example 3 and Comparative Example 3, respectively, after the 500-hour treatment with the aqueous KOH solution. As shown in FIG. 1, the appearance and cross section of the anion exchange membrane of Example 3 were good even after the KOH treatment. On the other hand, the appearance of the anion exchange membrane of Comparative Example 3 was poor because bumps were formed therein by the KOH treatment. Such deformation causes poor contact at the interface between the electrode and the membrane of a fuel cell, resulting in an increase in the resistance and a decrease in the output of the fuel cell.

### INDUSTRIAL APPLICABILITY

The present invention can be applied to an anion exchange membrane and a method for producing the same. The anion exchange membrane obtained by the present invention can be used as an electrolyte membrane having anionic conductivity for use in a membrane-electrode assembly and a fuel cell using the same.

1. A method for producing an anion exchange membrane, comprising the steps of:
(i) irradiating a first polymer film with radiation; and
(ii) graft-polymerizing a monomer containing a site into which a functional group having anion conducting ability can be introduced and an unsaturated carbon-carbon bond onto the radiation-irradiated first polymer film so as to form a second polymer film containing grafted chains, wherein
the method further comprises the subsequent steps of:
(a) subjecting the second polymer film to a treatment including irradiation with radiation so as to introduce a crosslinked structure into the grafted chains; and
(b) introducing the functional group having anion conducting ability into the site.

2. The method according to claim 1, wherein the step (b) is performed before or after the step (a).

3. The method according to claim 1, wherein the step (a) further comprises a treatment of heating the second polymer film after the irradiation with radiation.

4. The method according to claim 1, wherein a polymer constituting the first polymer film contains at least one selected from the group consisting of polystyrene, polyetheretherketone, polyetherketone, polysulfone, polyethersulfone, polyphenylene sulfide, polyarylate, polyetherimide, aromatic polyimide, polyamideimide, polyethylene, polypropylene, polyvinylidene fluoride, polyvinyl fluoride, ethylene-tetrafluoroethylene copolymer, vinylidene fluoride-hexafluoropropylene copolymer, crosslinked polytetrafluoroethylene, tetrafluoroethylene-perfluoroalkyl vinyl ether copolymer, and tetrafluoroethylene-hexafluoropropylene-vinylidene fluoride copolymer.

5. The method according to claim 1, wherein the monomer is halogenated alkylstyrene.

6. The method according to claim 1, wherein a weight of the second polymer film is in a range of 1.3 to 4.0 times a weight of the first polymer film.

7. An anion exchange membrane produced by the method according to claim 1.

8. A fuel cell comprising a membrane-electrode assembly including an anion exchange membrane, wherein
the anion exchange membrane is the anion exchange membrane produced by the method according to claim 1.
